(19) United States
(12) Patent Application Publication
(10) Pub. No.: US 2025/0271581 A1
(43) Pub. Date: Aug. 28, 2025

(54) META-DEVICE FOR NUCLEAR RADIATION DETECTION AND MANUFACTURING METHOD THEREOF

(71) Applicant: CITY UNIVERSITY OF HONG KONG, Kowloon (HK)

(72) Inventors: Rong LIN, Hong Kong (HK); Mu Ku CHEN, Sham Shui Po (HK); Din Ping TSAI, Hong Kong (HK)

(73) Assignee: CITY UNIVERSITY OF HONG KONG, Kowloon (HK)

(21) Appl. No.: 18/740,696

(22) Filed: Jun. 12, 2024

(30) Foreign Application Priority Data
Feb. 23, 2024 (CN) 202410205002.8

(51) Int. Cl. G01T 1/20

(52) U.S. Cl. CPC G01T 1/2002; G01T 1/20187

(57) ABSTRACT

A meta-optic device for detecting nuclear radiation. The device includes an image sensor, a scintillator, a meta-lens module disposed between the image sensor and the scintillator, and a reflective structure for defining a direction of motion of visible light photons generated by the scintillator. The scintillator is adapted to absorb nuclear radiation to generate visible light photons. The meta-lens module converges the visible light photons generated by the scintillator and transmits them to the image sensor so that an energy density of the visible light photons reaches the detection threshold of the image sensor. Due to its compact size and thin weight, the above meta-optic device is particularly suitable for daily radiation detection and environmental monitoring.

### CROSS-REFERENCE TO RELATED APPLICATIONS

The present application claims priority to Chinese Application No. 202410505002.8 filed on Feb. 23, 2024, which application is incorporated herein by reference in its entirety.

### FIELD OF INVENTION

The invention relates to nuclear radiation detection devices, and in particular to portable nuclear radiation detection devices.

### BACKGROUND OF INVENTION

Nuclear radiation, also known as ionizing radiation, refers to particle and electromagnetic wave nuclear radiation emitted by radionuclides, mainly alpha, beta, and gamma rays. Exceeding a certain dose of nuclear radiation poses a potential health risk to living organisms. In order to protect human beings and the environment from the hazards of nuclear radiation, the need for nuclear radiation monitoring activities is increasing day by day. Among them, portable nuclear radiation monitoring equipment plays an important role in emergency response to nuclear radiation, monitoring of the radiation environment, and public awareness and education because of its ability to provide immediate and reliable radiation measurements and monitoring.

Conventional portable nuclear radiation monitoring equipment is usually based on photomultiplier tubes or Geiger counters, which are large and heavy, making daily monitoring difficult. For example, a typical Geiger counter-based device has a dimension of 3.05 cm×10.51 cm×19.05 cm. Geiger counters are usually used for detecting beta particles, but have low sensitivity for detecting gamma rays. On the other hand, typical photomultiplier tube (PMT)-based devices are larger than those based on Geiger counters and have two parts, including the photomultiplier tube and a handheld device. As a result, such devices are large, require two hands to operate, and are difficult to carry around on a daily basis, making detection difficult. In addition, the detection results of such devices only display numerical values and have a weak visualization capability.

### SUMMARY OF INVENTION

Accordingly, the present invention, in one aspect, is a meta-optic device for detecting nuclear radiation. The device includes an image sensor, a scintillator, a meta-lens module disposed between the image sensor and the scintillator, and a reflection structure for restricting a direction of motion of visible light photons generated by the scintillator. The scintillator is adapted to absorb nuclear radiation to generate visible light photons. The meta-lens module converges the visible light photons generated by the scintillator and transmits them to the image sensor so that an energy density of the visible light photons reaches a detection threshold of the image sensor.

In some embodiments, the image sensor is substantially planar in structure. One side of the meta-lens module is adjacent to the image sensor and another side of the meta-lens module is adjacent to the scintillator. The scintillator has a substantially cuboid shape.

In some embodiments, the meta-lens module is a meta-lens array that includes a plurality of meta-lenses. These meta-lenses are arranged substantially in the same plane.

In some embodiments, each of the plurality of meta-lenses in the array of meta-lenses has the shape of a regular polygon or circle.

In some embodiments, each of the plurality of meta-lenses in the array of meta-lenses has a shape of a regular hexagon.

In some embodiments, each of the plurality of meta-lenses in the array of meta-lenses has a shape of a regular polygon, wherein at least two of the plurality of meta-lenses rest against each other by their side edges.

In some embodiments, the image sensor is a CMOS image sensor.

In some embodiments, the reflective structure is a reflective layer which covers the four sides of the cuboid shape of the scintillator, except for a first side of the scintillator abutting the meta-lens module, and a second side opposite that first side.

According to another aspect of the invention, there is provided a method for fabricating a meta-optic device for detecting nuclear radiation. The method contains the steps of providing an image sensor, forming a meta-lens module on the image sensor, forming a scintillator on the meta-lens module, and forming a reflective structure on the scintillator for restricting a direction of motion of visible light photons. The scintillator is adapted to absorb nuclear radiation so as to generate the visible light photons. The meta-lens module is used to converge the visible light photons generated by the scintillator and transmit them to the image sensor so that the energy density of the visible light photons reaches a detection threshold of the image sensor.

According to a further aspect of the present invention, a portable nuclear radiation detection device is disclosed, which includes a meta-optic device, and a display device connected to the meta-optic device. The display device is adapted to display nuclear radiation detection results in an image.

Some embodiments of the present invention therefore combine a scintillator and a meta-lens array integrated on an image sensor to realize a truly ultra-thin and ultra-light portable nuclear radiation monitor. The scintillator can release visible light photons after absorbing the main constituent particles of nuclear radiation and electromagnetic waves, and the meta-lens array is responsible for receiving and converging the visible light photons released from the scintillator to reach the signal threshold of the image sensor, and by analysing the captured images, the radiation dose can be calculated. This is because the planar meta-lens array increases the photon energy density so that the detection threshold of the image sensor is reached without having to use a photomultiplier tube.

As a result, the energy density of the converted photons is increased by using the ultra-thin meta-lens array so that the visible light captured by the above element can reach the minimum effective brightness. This function is similar to that of a photomultiplier tube, but in a more compact size. In addition, the present invention allows for the construction of meta-lens arrays directly on the imaging sensors when their materials are compatible, thereby further reducing the size of the components.

Due to its compact size and thin weight, the above meta-optic device is particularly suitable for routine radiation detection and environmental monitoring. The compact size of the element (compressed by a factor of nearly a hundred) allows the user to operate the corresponding portable radiation detection equipment with one hand, which greatly enhances portability. Furthermore, the element can be integrated with an image sensor and the detection results are displayed as an image, which provides visualization capabilities and is easy to understand.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1 illustrates a perspective view of the internal structure of a meta-optic device for detecting nuclear radiation according to a first embodiment of the invention.

FIG. 2 is a side view of the internal structure of the meta-optic device of FIG. 1, which illustrates example paths of radiation and light.

FIG. 3 is a state schematic of how the meta-optic device of FIG. 1 works for generating and converging visible light photons.

FIG. 4 illustrates a block diagram of the internal structure of a portable nuclear radiation detection device according to an embodiment of the present invention.

FIG. 5 is a flowchart of a method for calculating a radiation dose based on a captured photon image of the meta-optic device of FIG. 1.

FIG. 6a illustrates a three-dimensional view of a meta-unit based on geometric phases in designing a meta-lens.

FIG. 6b illustrates a top view of the geometric phase based meta-unit of FIG. 6a.

FIG. 7a is a schematic diagram of a phase distribution of a meta-lens of a circular shape, according to an embodiment of the invention.

FIG. 7b is a schematic view of a phase distribution of a meta-lens of a square shape, according to an embodiment of the invention.

FIG. 7c is a schematic diagram of a phase distribution of a meta-lens of a regular hexagonal shape, according to an embodiment of the invention.

FIG. 8a illustrates a schematic diagram of a meta-lens array formed by a plurality of the circular meta-lenses of FIG. 7a.

FIG. 8b illustrates a schematic diagram of a plurality of meta-lenses forming the array of meta-lenses of the square shape of FIG. 7b.

FIG. 8c illustrates a schematic diagram of a meta-lens array formed by a plurality of meta-lenses of the square hexagonal shape of FIG. 7c.

FIG. 9 is a flowchart of a method of fabricating a meta-optic device according to another embodiment of the invention.

FIG. 10 is a flowchart of a manufacturing method of a meta-lens according to another embodiment of the invention.

### DETAILED DESCRIPTION OF PREFERRED EMBODIMENTS

As used in the specification and the claims, certain terms are used to refer to particular components. It should be appreciated by those skilled in the art that a hardware manufacturer may refer to the same component by different terms. The specification and claims do not use differences in names as a means of distinguishing components, but rather differences in function of the components are used as a criterion for distinguishing them. The term “comprising” as mentioned throughout the specification and claims is an open-ended term and should be interpreted as “including but not limited to”. “Generally” means that within an acceptable margin of error, the person skilled in the art is able to solve the described technical problem within a certain margin of error, and basically achieves the described technical effect.

In the description of the present invention, it is to be understood that the terms “center”, “longitudinal”, “lateral”, “length”, “width”, “thickness”, “top”, “bottom”, “front”, “back”, “left”, “right”, “vertical”, “horizontal”, “top”, “bottom”, “inside”, “outside,” “clockwise,” “counter-clockwise,” and the like indicate orientation or positional relationships based on those shown in the accompanying drawings, solely for the purpose of facilitating the description of the present invention and simplifying the description. They are not intended to indicate or imply that the device or element referred to must have a particular orientation, or be constructed and operated in a particular orientation, and therefore is not to be construed as a limitation of the present invention.

Furthermore, the terms “first” and “second” are used for descriptive purposes only and are not to be understood as indicating or implying relative importance or implicitly specifying the number of technical features indicated. Thus, a feature defined with the terms “first”, “second” may expressly or implicitly include one or more such features. In the description of the present invention, “more than one” means two or more, unless otherwise expressly and specifically limited.

In the present invention, unless otherwise expressly specified and limited, the terms “mounted”, “connected”, “coupled”, “fixed”, etc., shall be understood in a broad sense. For example, they may refer to a fixed connection, a removable connection, or a connection in one piece; a mechanical connection, or an electrical connection; a direct connection, or an indirect connection through an intermediate medium; or a connection within two elements. For those of ordinary skill in the art, the specific meanings of the above terms in the present invention may be understood on a case-by-case basis.

In the present invention, unless otherwise expressly provided and limited, a first feature “over” or “under” a second feature may include that the first and second features are in direct contact, or the first and second features are not in direct contact but by means of another feature between them. Furthermore, the first feature being “above” the second feature includes the first feature being directly above and diagonally above the second feature, or simply indicating that the first feature is horizontally higher than the second feature. The first feature being “below”, “under”, and “beneath” the second feature includes the first feature being directly below and diagonally below the second feature, or simply indicating that the first feature is horizontally lower than the second feature.

Unless otherwise defined, technical or scientific terms used herein shall have the ordinary meaning understood by a person having ordinary skill in the art to which the present invention belongs. The terms “first”, “second” and the like as used in the specification and claims of the present invention do not indicate any order, number or importance, but are used only to distinguish between different components. Similarly, the words “one” or “a” and the like do not indicate a limitation in number, but rather the presence of at least one element.

In order to make the objects, technical solutions and advantages of the embodiments of the present invention clearer, the technical solutions of the embodiments of the present invention will be described clearly and completely in the followings in conjunction with the accompanying drawings of the embodiments of the present invention. Obviously, the described embodiments are a part of the embodiments of the present invention and not all of the embodiments. Based on the described embodiments of the present invention, all other embodiments obtained by a person of ordinary skill in the art without the need for creative labor fall within the scope of protection of the present invention.

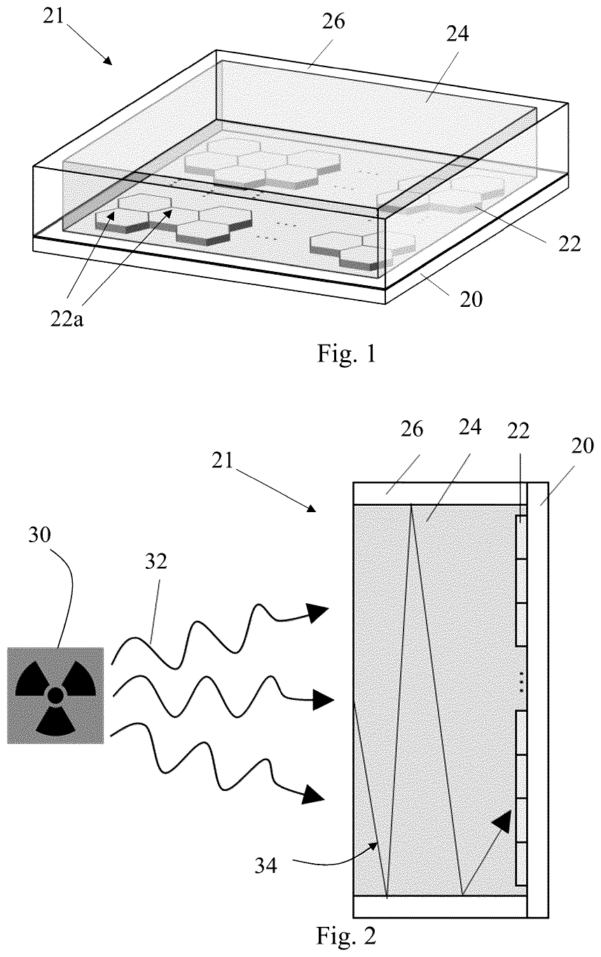

FIGS. 1-2 show a meta-optic device 21 according to a first embodiment of the invention, which has an overall cuboid shape. The meta-optic device 21 contains an image sensor 20 disposed at a bottommost location of the meta-optic device 21, a meta-lens module 22 disposed above the image sensor 20, a scintillator 24 disposed substantially above the meta-lens module 22, and a reflective layer 26 wrapped around the scintillator 24. As can be seen in FIG. 1, the scintillator 24 is substantially in the shape of a cuboid, and the reflective layer 26 covers the four sides of the cuboid shape except for the bottom side (i.e., the side of the scintillator 24 abutting the meta-lens module 22), and the top side. The top side of the scintillator 24 is adjacent to air, thereby serving as an incident interface to receive energetic particles and electromagnetic waves. In one embodiment, the reflective layer 26 may be made of barium sulfate. The reflective layer 26 serves as a reflective structure to prevent visible light photons generated by the scintillator 24 from escaping outside of the scintillator 24, and in particular by restricting the photons from escaping in a direction away from the meta-lens module 22 and making the photons (e.g., after one or more reflections) to move in a direction that is only toward the meta-lens module 22.

The scintillator 24 serves to release visible light photons after absorbing the main constituent particles of nuclear radiation and electromagnetic waves. Specifically, the scintillator 24 is capable of interacting with radioactive particles (such as gamma rays, x-rays, alpha particles, or beta particles) to convert incident radiant energy into observable visible light. However, the visible light photons exiting the scintillator 24 are not only weak in energy, but also have different exit angles, which barely reach the signal threshold of the image sensor. The problem of the exit angle is solved using the reflective layer 26 described above, and the problem of weak energy is solved using the meta-lens module 22 to be described in detail below. The material of the scintillator 24 may be CsI(Tl) (cesium iodide (thallium doped)), NaI(Tl) (sodium iodide (thallium doped)), BGO (bismuth germanium oxide) and the like. Different scintillator materials act on different kinds of radiating particles or rays, and emit visible light photons of different peak wavelengths after interaction of the scintillator material and the radiating particles or rays.

The image sensor 20 has a substantially planar shape as shown in FIG. 1. In a specific implementation, the image sensor 20 utilizes a CMOS (complementary metal oxide semiconductor) image sensor, which is made of silicon as its primary material. The image sensor 20 as shown above has a certain detection threshold, and if the light intensity (photon density) it receives is less than this threshold, it cannot be detected by the image sensor 20.

The meta-lens module 22 is sandwiched between the image sensor 20 and the scintillator 24 as shown in FIG. 1. That is, one side of the meta-lens module 22 abuts the image sensor 20 while the other side abuts the scintillator 24. In the embodiment of FIG. 1, the meta-lens module 22 is an array of meta-lenses that includes a plurality of meta-lenses 22a, which have the functionality of conventional lenses but are thinner and lighter than conventional lenses. These meta-lenses 22a are arranged substantially in the same plane, that is, a virtual plane parallel to the image sensor 20. In this embodiment, each of the meta-lenses 22a has a regular hexagonal shape. It can be seen that the plurality of meta-lenses 22a closely rest against each other, in particular via their respective side edges (i.e., the six edges of the hexagonal shape), forming a structure similar to a honeycomb. Thus, the periodic arrangement of the regular hexagonal shapes enables seamless tessellation, which can fully utilize the area of the image sensor 20 to the greatest extent possible and collect as many photons as possible. At the same time, the above-described meta-lenses 22a are arranged in a periodic arrangement to form an array. Such an array is necessary because the cross-sectional area of the scintillator 24 is larger than that of the individual meta-lenses 22a, and constructing the array makes full use of the area of the scintillator 24 so that all photons exiting from the scintillator 24 can converge through the array of meta-lenses. The above-described meta-lens modules 22 are characterized by their ultra-compactness, which have a thickness in the nanometer scale. The meta-lens array module 22 is capable of receiving and converging the visible light photons emitted by the scintillator 24 so as to reach the signal detection threshold of the image sensor 20. In one exemplary implementation, the material of the meta-lens 22a is SiN (silicon nitride).

Having described the structure and components of the meta-optic device 21 of FIG. 1, the operating principle of the meta-optic device 21 is now described. FIG. 2 illustrates a schematic diagram of the propagation of visible light photons emitted by nuclear radiation as well as scintillators. First, in the scenario shown in FIG. 2 there is a nuclear radiation source 30 (e.g., an ore, a nuclear contaminated object, a dust, etc.) that emits nuclear radiation 32, such as high-energy particles/electromagnetic waves (e.g., γ-rays, x-rays, α-particles, or β-particles) that are not visible to the naked eye. The nuclear radiation 32 from the nuclear radiation source 30 is received by the meta-optic device 21 and can be absorbed in multiple paths (three paths are schematically shown in FIG. 2) due to the large surface area of the scintillator 24 in the meta-optic device 21. The scintillator 24 converts the absorbed nuclear radiation 32 into visible light photons (not shown in FIG. 2). The visible light photons exiting the scintillator 24 as described above are not only weak in energy, but also have different exit angles and barely reach the signal threshold of the image sensor. However, in the presence of the reflective layer 26, these visible light photons do not leak out of the scintillator 24 to the outside thereof, but are bounced by the reflective layer 26, an exemplary bounce path 34 being illustrated in FIG. 2. In this way, the visible light photons, regardless of the number of reflections they may undergo, will only end up being passed towards the meta-lens module 22, and then be received by the latter.

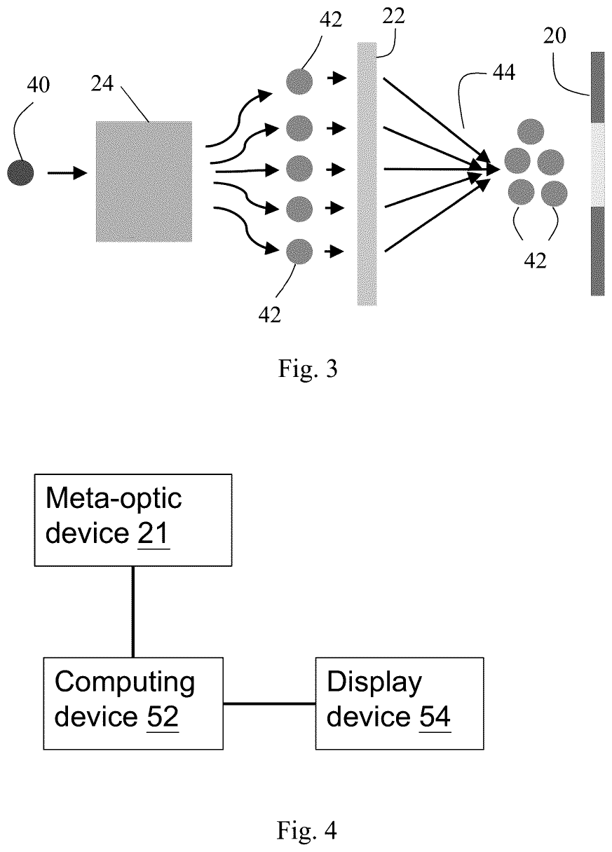

FIG. 3 then illustrates the operation of the meta-lens module 22 of the meta-optic device 21. Starting from the leftmost side of the figure, suppose that there is an energetic particle 40 which, upon entering the scintillator 24, releases a plurality of visible light photons 42 with different scattering angles, all of which are passed to the meta-lens module 22 (by means of the aforementioned reflective layer 26). Then, the visible light photons 42 are finally captured by the image sensor 20 after being received and converged (as shown by the arrow 44 of FIG. 3) by the meta-lens module 22.

FIG. 4 illustrates a block diagram of the structure of a nuclear radiation detection apparatus 50 according to an embodiment of the present invention. The nuclear radiation detection apparatus 50 contains the meta-optic device 21 shown in FIG. 1, a computing device 52 and a display device 54. The computing device 52 is connected to both the meta-optic device 21 and the display device 54. The computing device 52 (e.g., a CPU and a memory, etc.) is used to perform a conversion between the total intensity of the photon image and the radiation dose, and the display device 54 (e.g., a display screen) is used to display the nuclear radiation detection result in an image.

In particular, the image sensor 20 in the meta-optic device 21 will generate a corresponding photon image after capturing the accumulated visible light photons 42. After capturing the photon image information, the computing device 52 superimposes the intensity of each pixel within the image to obtain the total intensity Iₜ of the photon image, which is ultimately converted to obtain the radiation dose R. The exact relationship between the total intensity Iₜ of the photon image and the radiation dose R needs to be calibrated using a standard radiation source first. Here it is assumed that the relationship between the total intensity Iₜ and the radiation dose R is a first-order linear relationship R=aIₜ+b, and different Iₜ can be obtained by changing the dose R of the radiation source, which can be fitted to obtain the values of the coefficients a and b when there are sufficient samples. It should be noted that the accuracy of the conversion between total intensity and radiation dose is not only related to the number of samples, but also to the assumed fitting equation, which can be adjusted appropriately according to the actual situation, such as from a first-order R=aIₜ+b to a second-order linear relationship R=aIₜ²+bIₜ+c.

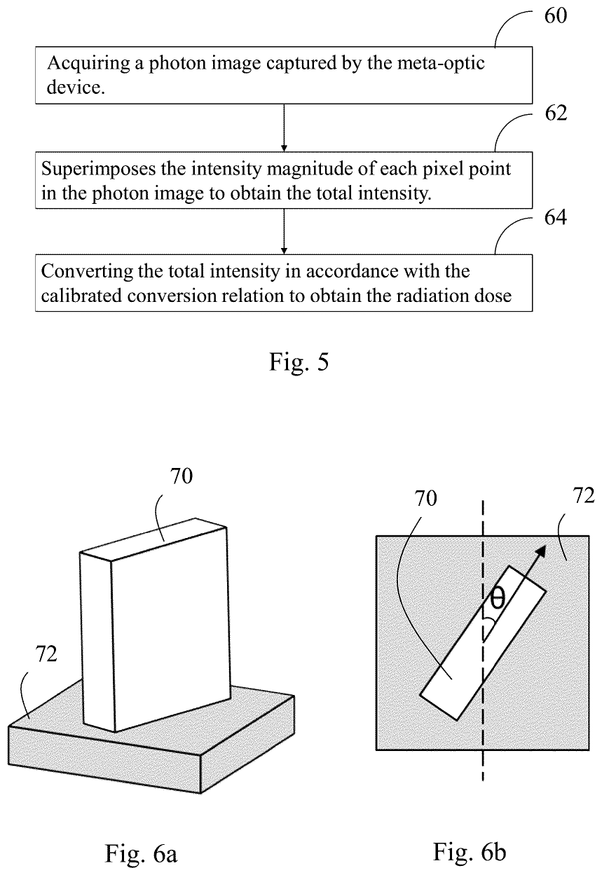

FIG. 5 illustrates specific steps for calculating the radiation dose derived from the photon image information obtained from the image sensor 20 by the computing device 52. First, in Step 60, the computing device 52 acquires the photon image captured by the meta-optic device 21. Then, in Step 62, the computing device 52 superimposes the intensity magnitude of each pixel point in the photon image to obtain the total intensity. Finally, the calculating device 52 converts the total intensity in accordance with the above-described calibrated conversion relation to obtain the radiation dose R. The radiation dose R may be displayed as an image, and thus may be visualized, and easily understood by a user.

In the following section, a method for designing a meta-lens (e.g., the meta-lens 22a in FIGS. 1-2) in an embodiment of the invention will be described. The phase distribution of the meta-lens is shown in the following equation (1).

$$φ ( x , y ) = \frac{2 π}{λ} ( \sqrt{{x}^{2} + {y}^{2} + {f}^{2}} - f ) \qquad ( 1 )$$

where λ is the wavelength of the incident light and f is the focal length of the meta-lens. The magnitude of the wavelength of the incident light can be determined according to the material type of the scintillator that is selected, because different scintillators have their corresponding peak wavelengths of luminescence. For example the peak wavelength of luminescence corresponding to CsI(Tl) is 550 nm, NaI(Tl) corresponds to 415 nm, and BGO corresponds to 480 nm and so on. According to the structural parameters and optical properties of the image sensor, the diameter and focal length of the corresponding meta-lens can be determined, and the phase distribution of the meta-lens can be finally determined.

Taking CsI(Tl) as an example, high-energy particles are transformed into multiple visible light photons with a wavelength of 550 nm after passing through a CsI(Tl) scintillator, and FIG. 7b shows the phase distribution of the meta-lens that allows these visible light photons to converge, and the diameter of the meta-lens is set to be 50 μm, and the focal length to be 10 μm, and in order to conform to the sampling principle, it is preferable for the period of the meta-unit to be less than λ/2, which is set to be 250 nm. It should be noted that the diameter of the meta-lens, the focal length, and the period of the meta-unit can be adjusted flexibly.

The corresponding phase distribution can be realized directly using the geometric phase or the propagation phase, where the magnitude of the geometric phase is related to the rotation angle of nanostructures in the unit cell. The nanostructures in the unit cell and their rotation angles are well-known to those of ordinary skills in the art. In the design of the meta-lens of embodiments of the invention, if the rotation angle of the nanostructure is θ, the corresponding geometrical phase of the meta-unit is 2θ. A reference schematic diagram of the geometrical phase based meta-unit is shown in FIGS. 6a-6b, wherein FIG. 6a shows a three-dimensional view and FIG. 6b shows a top view. The nanopillar 70 of FIGS. 6a-6b has a cuboid shape, which can also be changed to an ellipsoidal cylinder or other shapes with an aspect ratio of not 1:1 according to practical needs, and the shape of the substrate 72 is not fixed to a square, but a regular-hexagonal shape can also be used. Also, the range of the transmission phase is directly related to the volume ratio of the nanostructures, where the smaller the volume ratio of the nanostructures has, the smaller the propagation phase is, so that nanostructures of different sizes can be constructed to realize the corresponding phase distribution, and there is no special requirement for the aspect ratio of the nanostructures in this case.

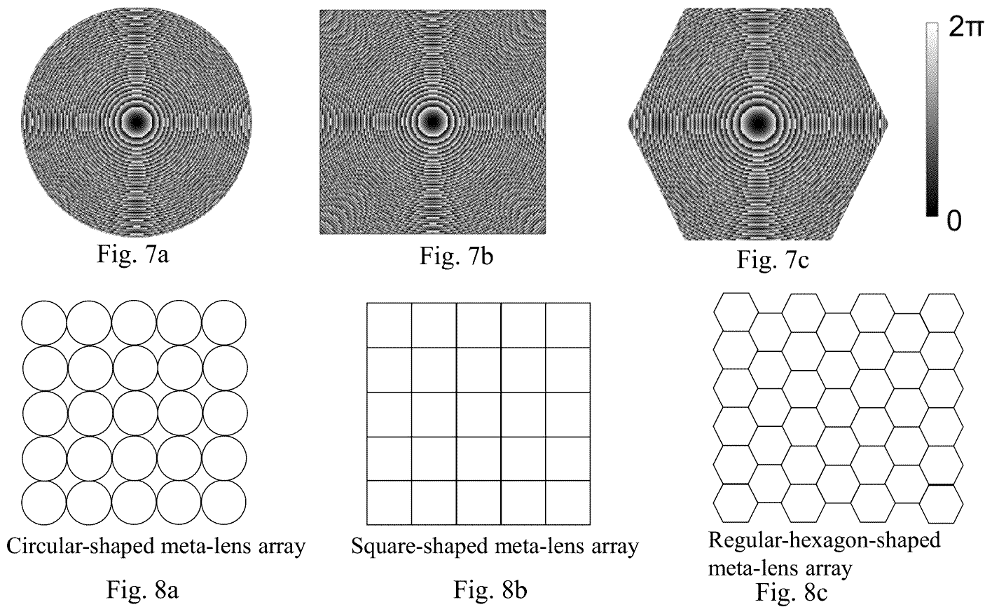

Next, the arrangement of the meta-lens array in an embodiment of the invention will be described in detail. After arranging the above-mentioned nanopillars 70 capable of realizing the corresponding phases to form a meta-lens (e.g., the meta-lens 22a in FIGS. 1-2), it is necessary to form an array of a number of the same meta-lenses. This is because, as described above, the cross-sectional area of a scintillator is generally larger than that of a single meta-lens, and constructing the array can make full use of the area of a scintillator, so that the photons emitting from the scintillator can be converged by the array of meta-lenses. The shape of the individual meta-lenses may be variable, such as regular polygonal or circular shape. In the embodiment of FIGS. 1-2, the shape of the meta-lens is regular hexagon, which is also shown in FIG. 7c. In the embodiment shown in FIGS. 7a and 8a, the shape of the meta-lens is circular, while in the embodiment shown in FIGS. 7b and 8b, the shape of the meta-lens is square. It is to be noted that the shape of the meta-lens in the form of a regular hexagon is particularly preferred, as it maximizes dense tessellation and fully utilizes the area of the image sensor.

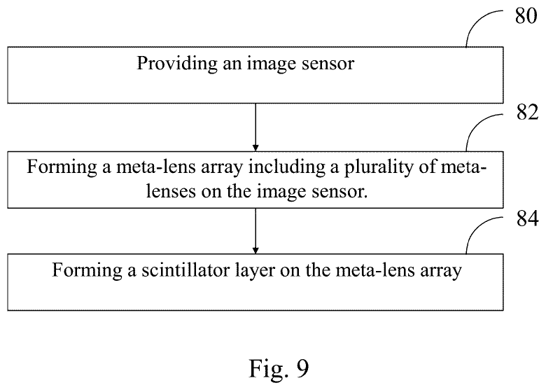

FIG. 9 shows the main steps of a method of fabricating a meta-optic device 21 (e.g., the meta-optic device 21 of FIGS. 1-3) according to an embodiment of the invention. First, an image sensor (e.g., the image sensor 20 in FIGS. 1-3) is provided in Step 80. Then, in Step 82, a meta-lens array including a plurality of meta-lenses is formed on the image sensor. Then, in Step 84, a scintillation crystal layer is formed on the meta-lens array. Although not shown in FIG. 9, the manufacturing method also includes other steps, such as wrapping a reflective layer around the outside of the scintillator.

In the following section, specific details of Step 82 in FIG. 9 will be described. The most critical aspect in the preparation of the meta-lens is etching, such as conventional lithography, laser direct writing lithography, laser interference lithography, electron beam etching, focused ion beam etching, probe scanning etching, nanoimprint etching, and microsphere projection etching techniques, all of which are well-known to those of ordinary skills in the art. In addition to the etching techniques, the deposition method needs to be used in conjunction with the deposition method to obtain a complete meta-lens. Depending on the material of the nanostructure and the processing equipment, the method for preparing the meta-lens can change accordingly.

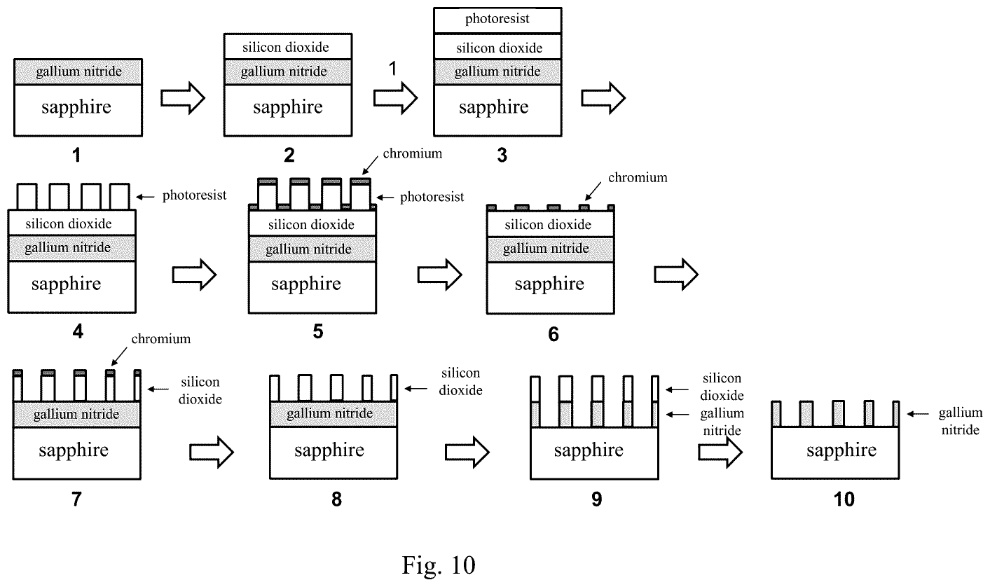

The followings are introduction of the complete fabrication process using the example of preparing gallium nitride nanopillars. Detailed steps of the method is as follows, and are shown in FIG. 10:
Step 1: Gallium nitride is deposited on a secondary polished sapphire substrate using chemical vapor deposition;
Step 2: Depositing silicon dioxide on the gallium nitride using plasma chemical vapor deposition;
Step 3: Spin-coating photoresist on the silicon dioxide;
Step 4: Etching the photoresist layer using an electron beam;
Step 5: Evaporating a chromium layer on the top surface of the photoresist layer using electron beam evaporation;
Step 6: Stripping the chromium layer;
Step 7: Using reactive ion etching technology to etch the silicon dioxide layer;
Step 8: Remove the chromium layer;
Step 9: Etching the gallium nitride using inductively coupled plasma etching technique to obtain nanopillars;
Step 10: Removing the silicon dioxide layer to obtain the final sample.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims. In the above, exemplary embodiments of the invention are fully described. Although the description refers to particular embodiments, it is clear to those skilled in the art that the present invention can be implemented with variations of these specific details. Accordingly, the present invention should not be construed as being limited to the embodiments described herein.

For example, the material selectivity for constructing the meta-lens of the present invention may be varied, and in addition to materials that can be directly grown on the image sensor as depicted in the embodiments of FIGS. 9 and 10, other materials may be selected, or even the meta-lens may be constructed directly using a scintillator material, thereby simultaneously realizing both the photon conversion and the convergence functions.

Similarly, the present invention has no limitation on the material of the scintillator, as long as it is capable of absorbing nuclear radiation and thus producing visible light. For example, the scintillator material may be BGO, NaI(Tl), CsI(Tl), LaBr3(Ce), or LaGPS, which have luminescence peaks of 480 nm, 415 nm, 550 nm, 380 nm, 390 nm, respectively.

In addition, the phase distribution of the meta-optic device can be varied with the requirements of the target, and boosting the energy density can be achieved in more ways than just photon convergence, e.g., by deflecting the photons to a uniform angle.

1. A meta-optic device for detecting nuclear radiation, comprising:
a) an image sensor;
b) a scintillator adapted to absorb nuclear radiation thereby generating visible light photons;
c) a meta-lens module disposed between the image sensor and the scintillator; and
d) a reflective structure for restricting a direction of motion of the visible light photons generated by the scintillator;
wherein the meta-lens module is adapted to converge the visible light photons generated by the scintillator, and transmit them to the image sensor such that an energy density of the visible light photons reaches a detection threshold of the image sensor.

2. The meta-optic device according to claim 1, wherein the image sensor is substantially planar in structure; one side of the meta-lens module being adjacent to the image sensor and another side of the meta-lens being adjacent to the scintillator; the scintillator having a substantially cuboid shape.

3. The meta-optic device according to claim 2, wherein the meta-lens module is a meta-lens array comprising a plurality of meta-lenses; the plurality of meta-lenses being arranged substantially in a same plane.

4. The meta-optic device according to claim 3, wherein each of the plurality of meta-lenses in the array of meta-lenses has a shape of a regular polygon or circle.

5. The meta-optic device according to claim 4, wherein each of the plurality of meta-lenses in the array of meta-lenses has the shape of a regular hexagon.

6. The meta-optic device according to claim 4, wherein each of the plurality of meta-lenses in the array of meta-lenses has the shape of a regular polygon; at least two of the plurality of meta-lenses resting against each other by their side edges.

7. The meta-optic device according to claim 1, wherein the image sensor is a CMOS image sensor.

8. The meta-optic device according to claim 2, wherein the reflective structure is a reflective layer which covers four sides of the cuboid shape of the scintillator, except for a first side of the scintillator abutting the meta-lens module, and a second side opposite the first side.

9. A method for fabricating a meta-optic device for detecting nuclear radiation according to claim 1, comprising steps of:
a) providing an image sensor;
b) forming a meta-lens module on the image sensor;
c) forming a scintillator on the meta-lens module; the scintillator adapted to absorb nuclear radiation thereby producing visible light photons; and
d) forming a reflective structure on the scintillator for restricting the direction of motion of the visible light photons;
wherein the meta-lens module is adapted to converge the visible light photons generated by the scintillator and transmit them to the image sensor such that an energy density of the visible light photons reaches a detection threshold of the image sensor.

10. A portable nuclear radiation detection apparatus, comprising:
a) a meta-optic device according to claim 1; and
b) a display device coupled to the meta-optic device;
wherein the display device is adapted to display nuclear radiation detection results in an image.
